(19) United States
(12) Patent Application Publication
(10) Pub. No.: US 2019/0292850 A1
(43) Pub. Date: Sep. 26, 2019

(54) Portable Ladder Platform

(71) Applicants: Shauna L. Weyrauch, Newark, OH (US); Walter A. Weyrauch, Newark, OH (US)

(72) Inventors: Shauna L. Weyrauch, Newark, OH (US); Walter A. Weyrauch, Newark, OH (US)

(21) Appl. No.: 15/934,980

(22) Filed: Mar. 24, 2018

(51) Int. Cl. E06C 7/16; E06C 7/50

(52) U.S. Cl. CPC E06C 7/16; E06C 7/50

(57) ABSTRACT

The Portable Ladder Platform is an innovative, convenient, sturdy portable ladder accessory for those who use a standard portable straight or extension ladder. The assembled invention provides a comparatively larger platform area for a more comfortable secure stance for anyone needing to work on a ladder for extended time. This invention abandons common platform arrangements that place the user standing outside the ‘safe zone’ (i.e., the area directly over the supporting rung, between the ladder side rails). A creative scheme includes the Locking Handle and the Horizontal Adjustment Screw which together secure the platform to the ladder during use. Emphasis toward user safety is reflected in elements reducing dangerous slipping and promoting platform stability. This ladder platform requires no tools to mount, moves easily and quickly from one level to another, and when mounted does not restrict ladder usage when stepping above or below the platform.

### CROSS-REFERENCE TO RELATED APPLICATIONS

Not Applicable

### STATEMENT TO FEDERALLY SPONSORED RESEARCH OR DEVELOPMENT

Not Applicable

### REFERENCE TO SEQUENCE LISTING

Not Applicable

### BACKGROUND OF THE INVENTION

### Field of the Invention

The invention relates generally to ladder platform attachments that provide enhanced comfort, function, and safety for a user when standing on a ladder.

### Problems Involved in the Prior Art

The Portable Ladder Platform was conceived as a unique portable alternative solution to achieving a more comfortable and safe position while standing on a ladder. Further, it is noted here the Portable Ladder Platform is simultaneously recognized as a useful tray platform to provide a portable ladder mounted shelf for holding work items on a rung ladder.

Typically, various ladder platforms have been devised requiring the user to set up complex, heavy, and cumbersome mechanisms, some requiring tools and/or elaborate adjustments to secure to a ladder. Such inconvenient requirements create unnecessary safety risks during installation and can discourage platform use. Other devices have been offered with structurally simplistic designs that do not encompass potential functionality and/or durability characteristics leaving the invention inherently unsafe when used as intended.

Most portable ladder platform designs fail to account for other safety issues including metal construction creating a lightning attractor as well as a conduit for unintended electrical shorting. Ladder platform designs in use today often place user's stance on a platform base positioned outside what is known for purposes of this application as a ladder's ‘safe zone’ (i.e., the area directly over the user's supporting rung, between the ladder side rails). A stance outside the ‘safe zone’ shifts the user's weight to a position backward from the ladder which works against the tilt of the ladder, leaving the potential for tipping away from its proper placement (e.g., leaning against a wall).

Accounting for good platform stability when in place on the ladder is not always considered by platform designs in use today. Any unexpected platform movement when in its mounted position can cause loss of user balance and resulting accidents. Further, concern for good footing is overlooked by some platform designs, leaving a metal platform base with poor traction likely slippery particularly when wet.

A second problem inherent with ladder platform configurations which place users away from a ladder exists as the mounted device becomes an obstacle for the user. With the platform in place on the ladder, the ability of the user to climb up or down past the platform becomes dangerous or practically impossible without removing the platform first. Some devices solve the platform obstacle by requiring an awkward kicking down movement with one foot while standing on the upper adjacent rung. Asking such agility likely is uncomfortable for many users standing on a ladder, and appears to increase user peril of suffering an accident in the process.

A potentially dangerous problem related to many current ladder platform devices which place the platform base outside the ‘safety zone’ is the unrestricted ledge created that requires the user to maintain footing carefully over the base. When using these platforms any misstep moves the foot beyond the platform base, over the unrestricted ledge and increases the likelihood of falling from the ladder.

Other portable ladder platforms fail to account for user safety by overlooking platform to ladder unintended movement issues. Other designs do not address horizontal slipping when platform base is in mounted position. Also, many platform inventions hope to avoid loss of platform stability when mounted to a ladder by leaving simple platform to ladder contact friction to keep the platform device in place. Avoiding risks brought on by poorly constructed platforms for standing on a ladder should be a primary objective when designing such a device. However, safety related concerns are typically not addressed by many contemporary portable ladder platforms marketed today.

### Description of the Prior Art

U.S. Pat. No. 169,236 to Case et al. Issued October 1875, one of the oldest relevant patents researched, discloses the Removable Ladder Step Device that is one of two (see Collins below) inventions found with basic features closest to the present Portable Ladder Platform invention. The Case et al. device arrangement overall is comparable as it also uses a two rung support arrangement whereas a lower rung supports the front of the base, and an upper adjacent rung supports the rear. Also, hooks are included for platform to upper rung connections; and the base extends inward (rather than outward) from the supporting lower rung. Not similar is the Case et al.'s invention's use of a ‘confinement box’ device to enclose the upper support rung (as opposed to entrapping the lower rung) to eliminate accidental displacement of the device when mounted to a ladder. The restriction of the Removable Ladder Step Device's 90° inverted base supporting bars limits base area. The present invention applies separate upper rung serpentine-shaped hook ‘hanger’ arms that attach to the base at rear-base corner hinge assemblies. The hanger arms are shaped to allow arm to base contact deeper than a 90° drop from upper rung, permitting a significant increase in useful base standing area.

U.S. Pat. No. 1,920,552 to Dollerhide reveals a similar basic design as Case et al. (above). Two rods with hooks rest over a ladder's upper rung to support the rear of an inward extending base. The opposite ends of the rods fix to the rear of a metal base; the front of the base itself shaped to hook over the lower supporting rung. The usable base area appears comparable to the present invention. Dollerhide's invention presents relatively simplistic construction reflecting little concern for safety enhancements or adaptability to various ladder types.

U.S. Pat. No. 407,079 to Laskey titled Ladder Platform Bracket issued Jul. 16, 1889 offers a single centered rear base supporting hooked bar arm to fix to the upper rung. While the base area is comparable to the present invention, such a design does not account for weight shifts to the poorly supported rear corners of the base and one can assume this device is inherently unstable.

U.S. Pat. No. 2,500,559 to Miller Ladder Platform places the base extending inward, as with several other patented inventions described herein. Miller's invention uses a two rung support (as does Case et al, Dollarhide, Laskey, and others) whereas the lower rung of the two is the front base area supporting rung and the adjacent upper rung is the rear base area supporting rung. The hanger arms are rods with hooks turned to approach the upper rung from back to front. This arrangement creates mounting obstacles on many contemporary ladders that restrict space behind the rungs. The hooks for fixing to upper and lower rungs are shaped strictly for round rung ladders, although adjustments could be made to permit other rung sizes and shapes. The present invention accounts for fitting to a variety of rung sizes and shapes commonly used today.

U.S. Pat. No. 2,801,886 to Peterson titled Combination Step and Scaffold Shelf for Ladders is a unique design attempting to permit reversing the device so that the base can be mounted inward (as a step) or outward (as a scaffold shelf) from the lower supporting rung. To mount the base inward a pair of chains are fastened to the left and right rear (inward) corners of the base. The chains are equipped with hooks designed to fix the chains to the second rung above the lower rung. The present invention confines mounting to two adjacent rungs to limit involving obstacles behind the rungs and to keep device dimensions minimized. Because chains, straps, ropes and wires being limp and difficult to control can cause mounting difficulties while standing on a ladder, the present invention does not involve them in its design. The front of the base of Peterson's device simply rests on the lower rung. Reversing the invention to extend outward provides a dubious scaffold shelf that appears to be unusable.

U.S. Pat. No. 9,834,988 to Arduna titled Ladder Platform Attachment discloses a platform base that uses two adjacent rungs with the base resting unfixed on the lower rung. A single serpentine shaped hanger arm rod vertically beneath the upper support rung and centered between the ladder rails is fixed via a rearward facing hook to the upper rung. The rod protrudes into a cavity in the floor of the base and ‘T’s to turn 90° left and right outward to provide base support for the rear of the base. Claimed to be designed “for increasing a person's safety when standing on a ladder”, the lack of secure, stable mounting across the rear of the base floor—imperative to supporting a user's weight—appears to invite side to side movement of the device leaving it unsafe when employed as intended.

U.S. Pat. No. 3,899,045 to Geisel, et al. titled Ladder Platform reveals “A safety platform for conventional ladders.” This invention shares several features with the present invention, including a two adjacent rung mounting design, rear base supporting rear facing hooked upper rung hanger arms, and a base front rung hook that supports the front of base. An interesting “safety latch, gravity biased to a latched position” located behind the upper support rung “prevents relative movement between the platform and the ladder” seems innovative. Geisel's safety latch, however, when mounted to a typical extension ladder, would fail to properly mount due to interference behind the outer upper support rung. Similar in intent, the present Portable Ladder Platform invention promotes a unique Locking Handle feature which, when closed, traps the lower support rung in a ‘confinement box’ and prevents unintended dismounting of the device without interference.

U.S. Pat. No. 4,482,030 to Lincourt titled Support Platform discloses another device similar in basic design to the present Portable Ladder Platform invention. Those include a rearward extending base, a two adjacent rung mounting design, rear base supporting rear facing hooked upper rung hanger arms, and a base front rung hook that supports the front of base. For this invention the upper and lower rung hooks are shaped from outer flat iron bans that support the left and right sides of base (see Case et al. above). The invention appears to properly support the base; however, no attention to accidental displacement of the mounted device has been applied leaving the device a poor safety design.

U.S. Pat. No. 4,911,265 to Skaggs titled “Ladder platform with rung securing mechanism” discloses basic design similar to the present invention and others (see Case et al. above). The area of inventive interest with Skaggs' offering concerns two unique rung fixing mechanisms to stabilize the mounted platform. A gravity biased bar pivots above and behind the upper support rung, and, when allowed to drop down, appears to encase the rung successfully in a confined space. A lower support rung “locking element” is somewhat less clear in its purpose. The action for locking the lower support rung involves wedging the rung between a stop and a spring biased mechanism, suggesting horizontal stabilizing of the base.”

U.S. Pat. No. 4,909,351 to Johnson, et al. titled Platform attachment for a ladder discloses a device which uses the basic design similar to the present invention and others (see Case et al. above). This invention incorporates a distinctive fixing technique using the upper supporting rung to secure the platform to a ladder. Long screws with wing nuts are arranged behind and beneath the upper rung by tightening them in positions available through holes in the two upper arm hanger bar hooks. This feature is of comparative interest in respect to the placement of an entrapping mechanism (two elongated screws) beneath the upper support rung. A resistance below the upper rung—the lower hanger arm jaws as used by the present invention—prevents base tipping and teetering over the lower support rung when user weight is applied. This is an important detail in design particularly when the platform base floor extends outward beyond the front edge of the lower rung.

U.S. Pat. No. D248777 to Spencer et al. titled Ladder Platform issued Aug. 1, 1978 offers one of the early devices of a contemporary commercially successful basic design. Such ladder platforms typically apply an outward extended base supported by two adjacent rungs where the upper rung supports the rear of the base and the lower rung supports the front of the base. The upper rung rests directly on the base, using an edge stop bar that extends downward from the rear edge of the base to prevent the base from disengaging the support rung. The lower rung supports the front of the base using two rods (or bars) fixed to the front corners of the base. Typically, U-shaped hooks attached to the lower ends of the support rods rest on the lower rung. Base arrangement outside the ladder's ‘safe zone’ (i.e. standing between ladder rails directly over the supporting rung) leaves the user of this basic configuration on a virtual cliff where a simple misstep can lead to falling and serious injury. Shifting user weight away from the ladder promotes ladder instability. Spencer et al.'s device, and similar devices, once mounted to a ladder, creates a block to user movement on a ladder, requiring an unnatural and potentially dangerous kicking of the device while standing on the rung above. Identifying the general weaknesses of Spencer et al, and very similar ladder platform designs in use today provided inspiration for creating the present invention without them.

U.S. Pat. No. 4,646,878A to Moyer titled Portable ladder step filed Jun. 27, 1986. Moyer's invention uses a lower rung base support and upper rung hanger support, similar to the present invention; however, the base extends outward from a ladder posing the various problems discussed herein.

U.S. Pat. No. 5,429,205A to Collins; David titled Ladder platform accessory filed Jun. 20, 1994. Collins' device shares several similarities with the present invention. Using the lower base rung/upper hanger rung support design with the base placed inward from the lower rung is relatively rare among searched patent grants. Beyond those details, an apparatus Collins included to secure the upper rung in a containment box is comparable to the present invention. The Portable Ladder Platform of this application uses a unique mechanism to trap the lower rung, instead, allowing a simple mounting procedure onto multiple ladder rung types. Collins' Ladder platform accessory requires setup adjustments and as offered, can be used exclusively on straight round rung ladders.

U.S. Pat. No. 4,401,187A to Van Patten titled Ladder platform accessory issued Aug. 30, 1983 is a device using a ladder lower rung for supporting the front of an inward mounted base and an adjacent upper rung for supporting the rear. The hanger rods used to support the rear employ hooks that are turned toward center to insert into the upper rung from outside the two ladder rails. This arrangement requires a ladder to have rungs with hallow ends open for such insertions, and thereby restrict the application. Further, this approach to finding hanger support appears to exclude mounting to extension ladders.

U.S. Pat. No. 1,452,182A to Butrum titled Platform ladder jack issued Apr. 17, 1923 offers a reversible platform device employing a ladder rung for support of one end of the base and one of two rungs to support the other end. The invention extends two support rods either upward two rungs—if the base is to be turned inward from a ladder—or downward two rungs—if the base is to be mounted outward from a ladder. This is a curious design, but appears to be viable. As with some other devices, Butrum's offering evidently requires careful set up adjustment, does not account for fitting to various ladder rung types, and lacks focus on safety concerns.

U.S. Pat. No. 5,337,857A to Spalt et al. titled Ladder adaptable platform issued Aug. 16, 1994. One postulation inferred by this application concerns the advantages of placement of the platform base of any ladder platform design over and inward from the base supporting rung. To that end, Spalt et al.'s invention succeeds by using a single supporting rung together with brackets to add support from the ladder rails. The device requires a fit between the brackets and rails, limiting the mounting to ladders with matching rails. The brackets also eliminate attaching Spalt et al.'s invention to extension ladders.

### SUMMARY OF THE INVENTION

The Portable Ladder Platform is a device designed to provide expanded standing space when mounted onto a common ‘D’ shaped rung equipped straight or extension ladder. It should be understood the present invention also mounts to other rung shapes; however, for the purpose of this description ‘D’ shaped rungs will be referenced. Further, the present invention's claimed innovations should be recognized as applicable to modified designs allowing fitting to other ladder types (i.e. step, folding, telescoping).

Standing for extended length of time in one position on a typical ladder is uncomfortable, asking the user to support their weight on relatively thin ladder rungs. Ladder platforms of various designs have addressed this problem, but have created other problems for the user. (See “Background of the Invention section.)

The Portable Ladder Platform presents an alternative platform that is portable and simple to mount onto ladder rungs requiring no tools.

Made of light weight yet strong molded nonconductive plastic rather than the near universal use of metals by other invention devices, the present invention will not draw lighting or conduct accidental electrical shorting.

Being relatively small and light weight permits the Portable Ladder Platform to be moved quickly and easily from one position on the ladder to another.

The standing area (base) of the platform is kept within the ‘safe zone’, over a supporting ladder rung and between the ladder rails. This arrangement maintains user weight distribution that ladder manufacturers expect.

The two upper rung hanger arms are designed to allow mounting to either single rail or extension ladders (where two abutting rails can be involved) with no modifications or adjustments.

An important innovative secure Locking Handle confines the lower rung (the rung supporting the front of the platform base) in a containment area during use. When mounting, the Locking Handle is lifted, moving two handle prongs up and out of the way. Once the user positions the Portable Ladder Platform on a ladder, the handle is lowered moving the prongs behind the supporting rung, preventing the platform from moving out of working position. Simply lifting the Locking Handle allows the present invention to be dismounted and repositioned to another rung, or removed from use.

The unique Horizontal Set Screw, once properly adjusted during mounting, removes any left to right looseness between the platform and the ladder rails, helping to stabilize the platform when in working position.

Designed to be safe and easy to use, the Portable Ladder Platform eliminates the awkward and potentially dangerous problem of climbing up or down past a mounted, outward protruding platform. The present invention keeps the platform base over and behind the supporting rung allowing the user to step from the upper or lower rung directly onto the platform, as well as stepping from the platform up or down to an adjacent rung with no obstruction.

### STATEMENT OF THE OBJECT OF THE INVENTION

The object of this invention is to bring to the market a ladder platform that is simple and easy to use as well as being thoughtfully designed to consider and minimize safety issues inherent in the use of any platform mounted to a ladder.

### BRIEF DESCRIPTION OF THE SEVERAL VIEWS OF THE DRAWING

Where there are drawings, you must include a listing of all figures by number (e.g., FIG. 1A) and with corresponding statements explaining what each figure depicts.

FIG. 1 is a front left to right 45 degree view of the upper side of the assembled invention. It shows details of the front, top, and left side of the invention as seen from this perspective.

FIG. 2A is a detail cutaway view of the right side of the assembled invention excluding the locking handle. It focuses on the base locking handle cradle and how it permits the locking handle to function.

FIG. 2B is a detail cutaway view of the right side of the assembled invention. It shows the locking handle seated in the locking handle cradle and the location of a base locking handle cradle limitation pad.

FIG. 2C highlights the function of a base locking handle cradle limitation pad when the locking handle is lifted.

FIG. 3 is a front left to right 45 degree view of the lower side of the assembled invention. It shows numbered details of the underside of the invention as seen from this perspective.

FIG. 4 shows the right side of the assembled invention and a cutaway view of a segment of a typical extension ladder. In this drawing the contact points where the invention mounts on the ladder are pointed out. It shows the cutaway views of a ladder's Support Rung A and Upper Rung B bearing the invention's base front and rear. Traction Pads for contacting Rung A and Rung B are indicated. This drawing also identifies the invention's Hanger Arm Lower Jaw Segment.

FIG. 5 (arranged on its page in landscape view) is an exploded view of FIG. 1. It provides an unrestricted look at the numbered individual parts of the invention from the front upper side of a left to right 45 degree perspective.

FIG. 6A is the first of two right side sequenced illustrations of the assembled invention. The sequence highlights the invention—a ladder platform—being placed and secured to a cutaway section of a typical ladder. FIG. 6A depicts a cutaway view of a segment of a typical ladder with the invention (platform) to its left. The platform has not been mounted to the ladder.

FIG. 6B is the second of two sequenced illustrations of the assembled invention showing the right side of the platform and a cutaway view of a segment of a typical ladder. This drawing shows the invention (platform) moved to mount with the ladder. It also shows the locking handle moved (lowered) to lock the lower rung in containment (locked) position.

FIG. 7A is the first in a sequence of five illustrations showing a front right to left 45 degree view of the upper side of the assembled invention. This drawing shows the right and left upper rung hook arms erected into mounting position.

FIG. 7B is the second of five sequenced illustrations. This drawing is an enlarged detail of the right rear corner of the assembled invention. It focuses on the right upper rung hook arm hinge and its snap lock's movement necessary to collapse the arm into transport/storage position.

FIG. 7C is the third of five sequenced illustrations. This drawing is an enlarged detail of the right rear corner of the assembled invention. It focuses on the right upper rung hook arm hinge and its snap lock released and the right upper rung hook arm collapsed into transport/storage position.

FIG. 7D is the fourth of five sequenced illustrations. FIG. 7D returns to full view of the assembled invention from the front right to left 45 degree upper side. This drawing shows the fully collapsed right upper rung hook arm, and suggests the same procedure is necessary to collapse the left upper rung hook arm.

FIG. 7E is the fifth of five sequenced illustrations. The figure shows the fully collapsed left and right upper rung hook arms.

FIG. 8A is the first of two front view sequenced illustrations of the assembled invention. This illustration shows a segment of a typical ladder with the invention (platform) in mounted position. Two motion arrows depict the screwing action of the horizontal adjusting screw, and the resulting leftward movement of the platform relative to the ladder.

FIG. 8B is the second of two front view sequenced illustrations of the assembled invention. This illustration shows the resulting horizontal movement of the platform assembly into a secure pinned position between the rails of the ladder.

FIG. 9A is the first of two right side views of two comparable ladder platform designs, how they mount on a standard ladder, and how the user's standing position is arranged. FIG. 9A illustrates a generic ladder platform design in use today mounted on a cutaway view of a typical ladder. An image of a user standing on the platform illustrates the user's position in relation to the ladder and as compared to the user's position on the invention (subject of this application) in FIG. 9B.

FIG. 9B is the second of two right side views of two comparable ladder platform designs. This drawing depicts the invention (subject of this application) mounted to a cutaway view of a typical ladder. An image of a user standing on the platform illustrates the user's position in relation to the ladder and as compared to the position on the generic ladder platform in FIG. 9A.

### DETAILED DESCRIPTION OF THE INVENTION

Climbing a typical contemporary portable straight or extension ladder to a height where the user will need to stand in place for an extended time on a relatively narrow ladder rung leads to user feet and leg fatigue and discomfort. To help address this problem ideas leading to portable (detachable) ladder platforms have produced a number of variations.

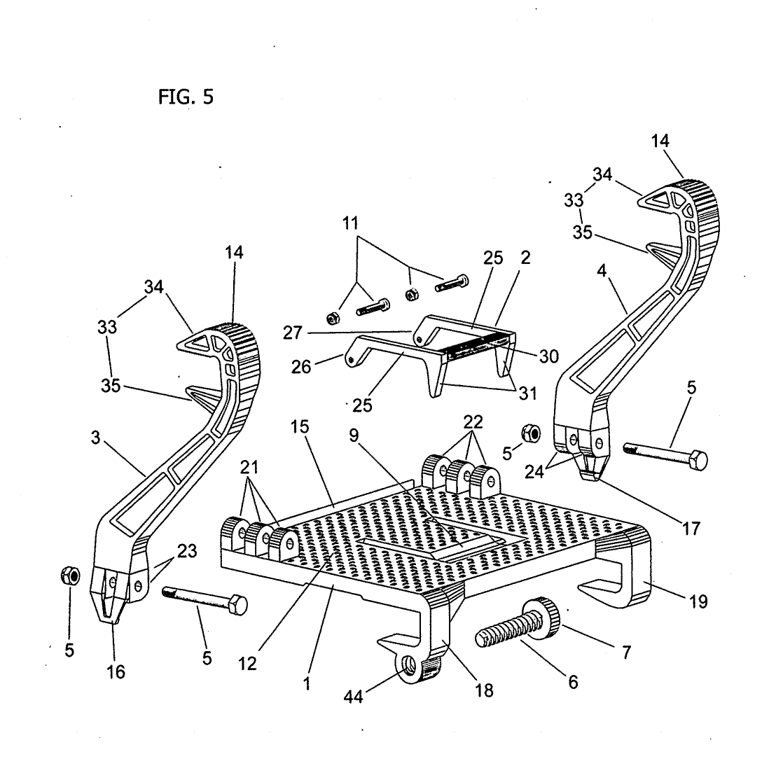

Mounting the Portable Ladder Platform to a ladder requires two steps: step 1 the user grasps with one hand the platform Locking Handle 2 (FIG. 5) lifting and inserting the invention into position so that the Base 1 rests in contact over a chosen ladder rung A. This step includes the subsequent passive insertion of two platform upper rung hanger arm hooks 3,4 to rest over a second adjacent rung B above rung A. Once the present invention is in position contacting the 2 rungs, the handle is released to drop into a locking position explained further below. Step 2 (also further explained below) has the user turn the horizontal adjustment dowel clockwise effectively moving the platform horizontally along the rungs until any excess gap between the platform and the ladder rails is closed. This mounting process is reversed to remove the platform from a ladder. When mounted the Portable Ladder Platform does not interfere with normal movements of stepping up or down a ladder.

No one platform design has been universally mounted to all existing ladder types. Varieties of ladders are many, with widely varying dimensions critical to properly fitting a ladder platform to them. That is why the present invention is intentionally limited in design to be mounted to a standard portable ‘D’ shaped rung straight or extension ladder that is popular today. Be it known the Portable Ladder Platform can be re-configured without adjustment to claims made herein to custom fit other types of ladders. Also, this initial platform design is proposed to be made of injection molded plastic parts; however, extruded aluminum can be an acceptable substitute. If the assembled invention's claims are reduced to simplify the design, steel could be used to fabricate its parts. The general design advantages described in this application should be transferable to nearly all portable ladder varieties that could benefit from a platform attachment.

As shown in FIG. 5, the Portable Ladder Platform is made of five separate molded plastic parts, along with four metal bolts and matching locknuts. The molded plastic parts include the Base 1 of the platform, Left Upper Rung Hanger Arm 3, Right Upper Rung Hanger Arm 4, a Locking Handle 2; and a coarse threaded Horizontal Adjustment Dowel 6.

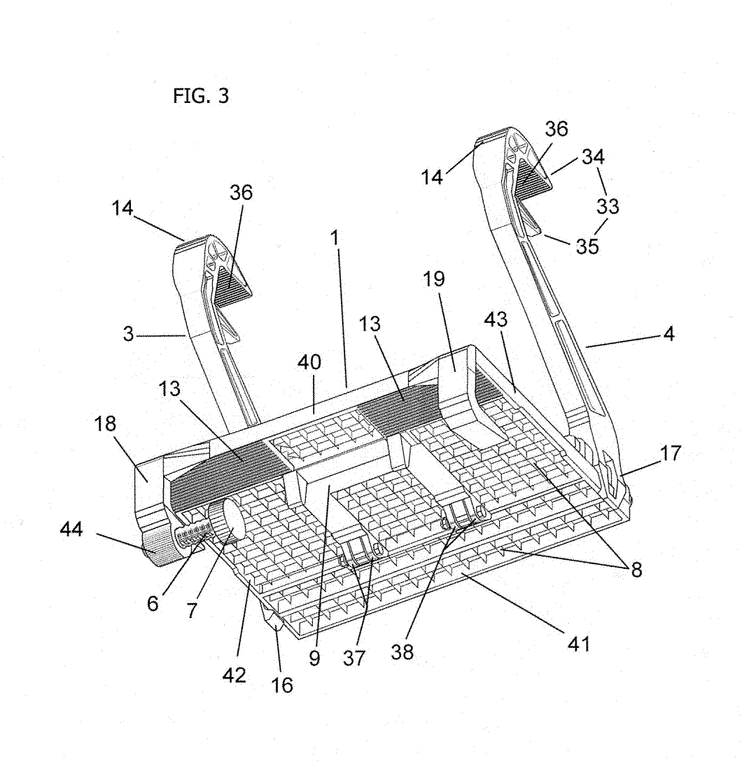

Referring to FIG. 3, the Base 1 is comprised of a rectangular floor of a size to maximize available area within practical limits existing broadly above a ladder rung and between the ladder rails. Base thickness, as well as thickness of all molded plastic parts is determined by consideration of required strength/stress tolerances verses ideal economy of production. Four perimeter walls equally extend vertically downward from the base; including Front Base Downward Reaching Vertical Wall 40, Rear Base Downward Reaching Vertical Wall 41, Left Base Downward Reaching Vertical Wall 43, and Right Base Downward Reaching Vertical Wall 44.

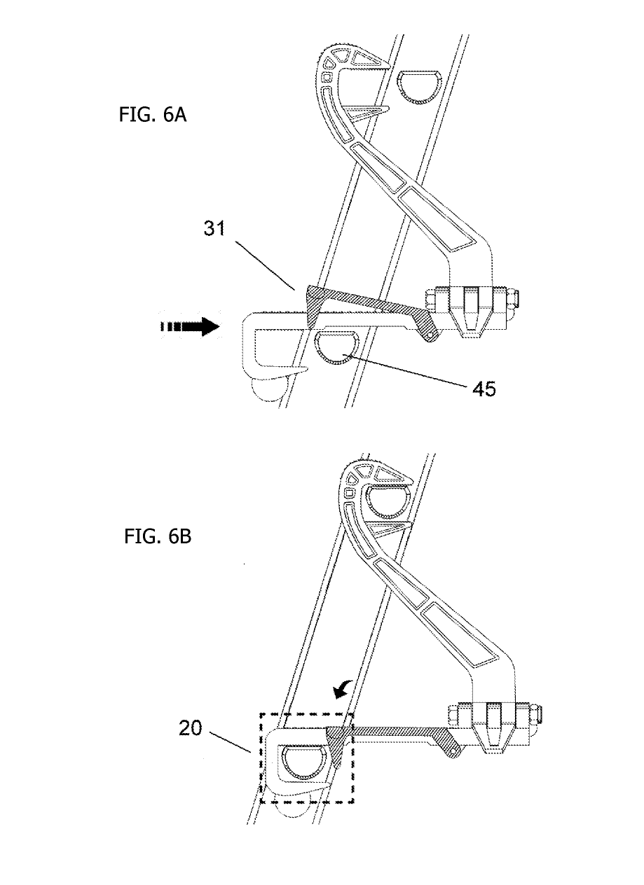

FIG. 3 identifies two modeled base extrusions from the front wall 40: These are the Left and Right Base Lower Rung Hooks 18,19, that reach downward from left and right front base wall corners and turn 90° rearward. FIG. 6A shows a right side view of a lower rung hook, together with a segment of a base side wall, creating three sides of a base lower rung hook. FIG. 6A & FIG. 6B illustrate the action of moving the present invention into mounting position on a typical ladder. FIG. 6A depicts the lower support rung 45 about to be encompassed on three sides by the right base lower rung hook 19. FIG. 6B shows the Locking Handle 2—dropping in place into the Base Locking Handle Cradle 9 (FIG. 3 and FIG. 5). Explained further below, the Locking Handle Gate Prongs 31 are then in position directly behind the lower support rung, obstructing its removal. Together with the three sides of the base lower rung hook, the lowered gate prongs complete a four sided rung containment ‘box’ 20 (FIG. 6B) that traps the rung from accidently moving out of mounted position. This innovative box mechanism helps to secure the Portable Ladder Platform against accidental platform dislodging while in use.

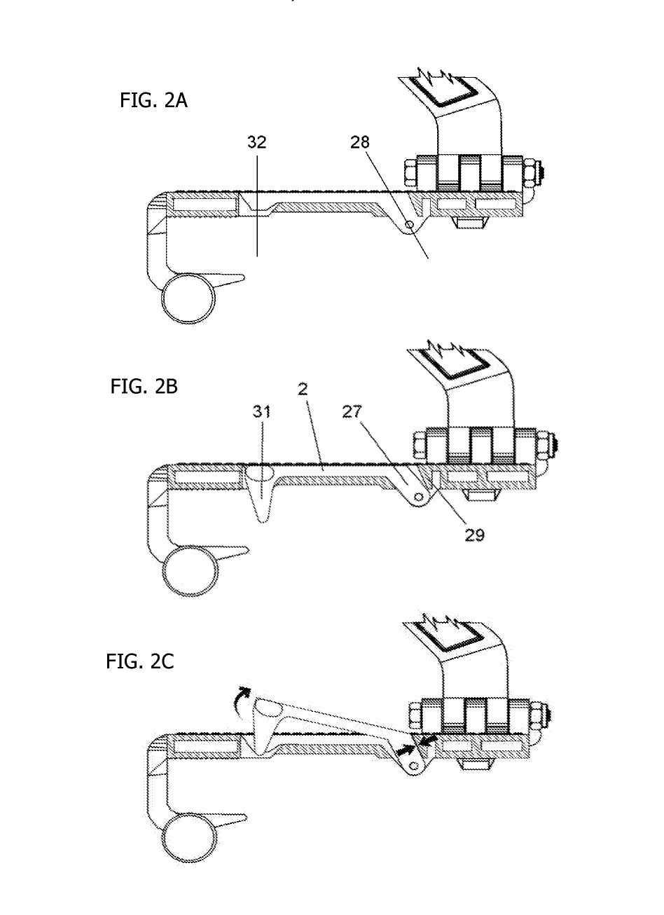

FIG. 2A is a detail cutaway view of the right side of the Portable Ladder Platform. The illustration focuses on the base locking handle cradle located in the general center of the base. The Locking Handle 2 is removed for clarity. The drawing locates a Base Locking Handle Cradle Hinge Knuckle Passage 28 and a Base Locking Handle Cradle Gate Prong Passage 32. The passages allow Locking Handle Hinge Knuckles 27 and Locking Handle Gate Prongs 31 to pass through openings in the base. FIG. 2B shows the Locking Handle 2 seated in place in the locking handle cradle. The 2 Base Locking Handle Cradle Limitation Pads 29 (pointed to in FIG. 2B) are features of the base locking handle cradle designed to restrict range of movement by the locking handle. Lifting the locking handle a measured amount raises the gate prongs enough to pass the lower support rung in or out of the containment box for mounting/dismounting the present invention from a ladder. Restricting the range of lift helps maintain user control of the platform during the mounting/dismounting process. FIG. 2C illustrates the restrained movement forced by the limitation pads.

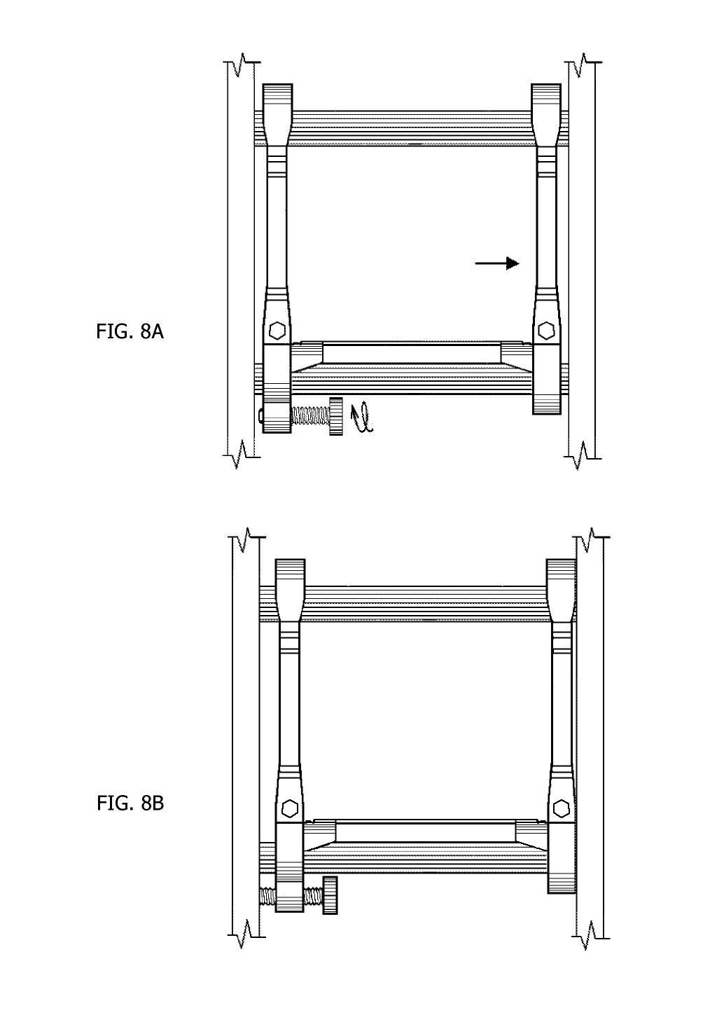

Again referring to FIG. 3, any unexpected movement of a mounted ladder platform, regardless how slight, can at least be distracting for the user, and potentially lead to accidents. Modeled from the lower section of the Left Base Lower Rung Hook 18 is the Left Base Lower Rung Hook Threaded Dowel Socket 44. The Threaded Dowel Socket is the coarse threaded fitting for the Horizontal Adjustment Dowel 6. The dowel has a matching coarse thread to screw through the socket. Modeled at the right end of the inserted adjustment dowel is a broadened circular Knurled Dowel Head 7 which allows the user to hand-adjust the dowel during mounting. As suggested in FIG. 8A, the dowel, when turned clockwise, moves right to left through the socket until the left tip of the dowel contacts the inner wall of the ladder's left rail. Turning the dowel further forces the movement of the entire platform rightward until the right side of the base is contacting the right ladder rail frame. This procedure, concluded in FIG. 8B, effectively removes excess horizontal space and pins the Portable Ladder Platform within the ladder rails, preventing horizontal movements. During platform dismounting the Horizontal Adjustment Dowel 6 is moved away from the pinned position by turning the knurled dowel head counter clockwise until the dowel is backed away enough for removing the platform.

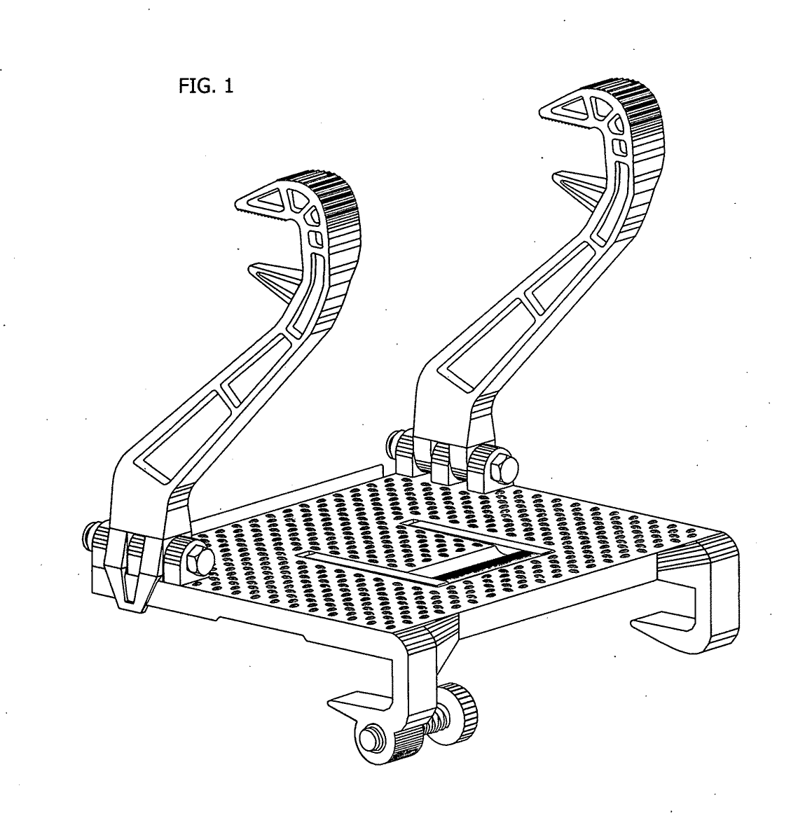

Referencing FIG. 5, upper rung hanger arms 3,4 are each attached to the base with a hardware bolt and locknut 5 serving as pins in left and right upper rung hanger arm to base hinge assemblies. FIG. 1 illustrates the assembled hinges in vertical (mounting) positions. The left and right upper rung hanger arm to base hinge assemblies are formed by Left and Right Base Hinge Knuckles 21,22 that are modeled to rise vertically from the left and right rear corners of the base. These base hinge knuckles fit to Left and Right Upper Rung Hanger Arm Hinge Knuckles 23,24 respectively that are modeled into the bottom ends of the Left and Right Upper Rung Hanger Arms 3,4.

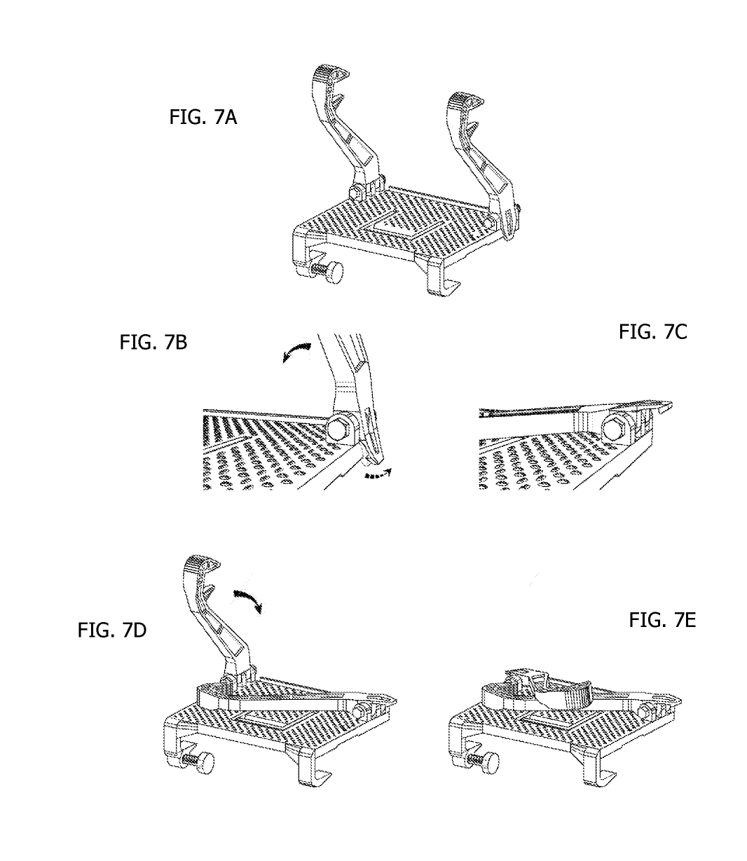

The present invention includes a mechanism permitting each upper rung hanger arm to collapse inward in a folding motion, effectively reducing overall Portable Ladder Platform height. Reducing overall height aids in transporting and storing the present invention. To lock the upper rung hanger arms into vertical position with respect to the base, Left and Right Upper Rung Hanger Arm Snap Latches 16,17 are employed. FIG. 7A through FIG. 7E present a stepped sequence of drawings discussed herein.

FIG. 7A is a view of the assembled present invention showing upper rung hanger arm to base hinges in the vertical position. In FIG. 5 Left and Right Upper Rung Hanger Arm Snap Latches 16,17 are extruded and modeled to protrude downward from the lower outboard sides of the Left and Right Hanger Arm hinge knuckles. The snap latches, when engaged with lower edge of the left and right base walls, maintain hanger arms in 0° vertical positions, preventing the upper rung hanger arms from collapsing inward. Conversely, upper rung hanger arms are blocked from pivoting outward from base beyond 0° vertical by hanger arm hinge knuckle modeling 23 (best illustrated by FIG. 5).

FIG. 7B illustrates a detail of the action of releasing the Right Upper Rung Hanger Arm 4 when pressure against the arm snap latch 17 bends it back enough to release the latch, allowing the arm to collapse inward. Once released and pressure is relieved, the snap latch returns to its unpressured position. The same procedure is used for both right and left snap latches.

FIG. 7C depicts a detail of the fully collapsed right upper rung hanger arm.

FIG. 7D suggests the identical procedure is necessary to collapse the left upper rung hanger arm.

FIG. 7E shows the altered platform profile created when both upper rung hanger arms are fully collapsed for transport or storage.

Referring again to FIG. 5, the Locking Handle 2 (explained above as providing two Locking Handle Gate Prongs 31 for trapping a lower support rung) is attached to the Base 1 using two hardware bolts and locknuts 11. The bolts and locknuts serve as pins in left and right locking handle to base hinge assemblies. Together with the pins the left and right locking handle to base hinge assemblies consist of two left and two right Locking Handle Cradle Hinge Knuckles 37,38 that are features of the Base Locking Handle Cradle 9. The knuckles are extruded downward below the cradle where they fit to left and right Locking Handle Hinge Knuckles 50,51 to complete the hinge assemblies. When the user engages the locking handle it pivots at the hinges to permit the handle to move upward or downward through a limited range. This movement allows mounting and dismounting the present invention to and from a ladder as the locking handle gate prongs open and close the lower rung containment box.

Relating to FIG. 3, the platform Base 1 is designed to be light weight yet strong employing injection mold cross ribbing and gussets where applicable. The illustration shows a Base Rib Array 8 that allows the removal of much of the base plastic mass without losing base integrity. Ribs are shaped and distributed as recommended by mold designers with details such as rounded corners to allow easier removal from the mold, and wall to rib widths to produce optimum strength and cosmetic finish to meet the Portable Ladder Platform's requirements.

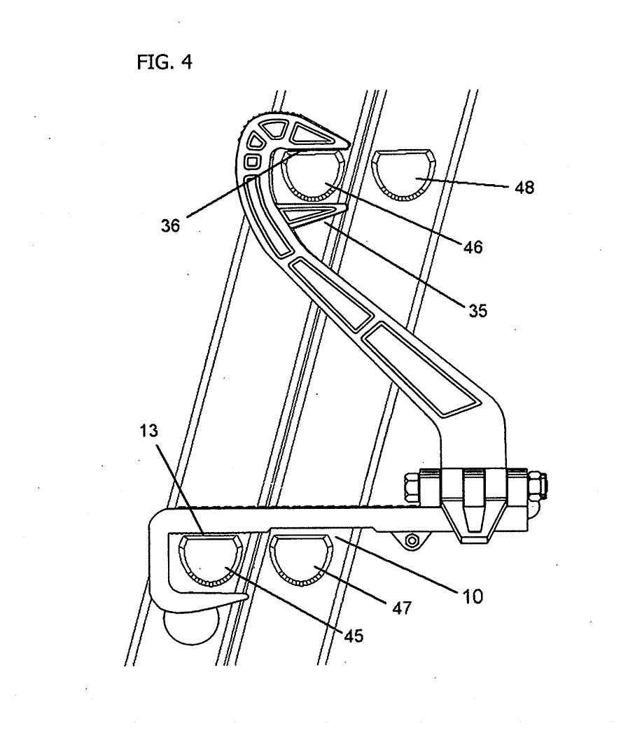

FIG. 3 shows two Corrugated Base To Lower Ladder Rung Traction Pads 13. FIG. 4 provides a right side view of a traction pad mounted over a Typical Lower Ladder Support Rung 45. Most D shaped ladder rungs have textured surfaces of various designs to limit slipping. Unnecessary slipping and movement between a ladder platform and the ladder rung can cause accidents. The present invention's traction pads help to insure good grip when contacting the rung.

Occupational Safety and Health Administration (OSHA) regulations set standards for various portable ladder measurements. Competing ladder manufacturers follow these standards which produces very similar dimensions in important areas leading to general uniformity in ladder production. This uniformity provides the information necessary to set optimal Portable Ladder Platform dimensions. As shown in FIG. 4 the underside of the platform device presented in this application has a floor size that takes advantage of maximum area within the ladder rungs. Compared to a ladder rung, the relatively ample space takes advantage of nearly all area practically available.

Rising as a modeled extruded feature from the base surface (FIG. 5) is the Base Traction Grid 12, a unique tread designed for enhanced traction.

When setting up a ladder, failing to set the ladder angle within manufacturers' recommended 70°-75° range can lead to accidents. Placing a ladder at a steeper angle temps ladder collapse, and produces a slanted platform angle that could make footing prone to slipping. Drawn in FIG. 5, along the back edge of the floor is a Base Rear Ledge Slip Guard 15. The slip guard is an extruded feature of the base forming an upward turned vertical ledge from the Rear Base Downward Reaching Vertical Wall 41. The ledge slip guard provides slip resistance and warns the user when the user's feet are at the back edge. The ledge slip guard also serves as a restraint to keep tools, paint supplies, etc. from sliding off the rear of the platform should it be used as a ladder caddy (shelf).

Reference FIG. 4 showing the right side of the present invention. When two rungs are together as a consequence of two segments of an extension ladder in alignment at the user's desired position (examples: 46/48, and 45/47), slight ladder manufacture variances can create interference with proper platform to rung seating. Should the Lower Secondary Rung 47 directly behind the lower support rung 45 rise above the support rung and contact the platform, a rocking or teetering effect will result. To prevent this potential unwanted contact when mounted to an extension ladder, a Lower Base Recessed Area 10 transverses the underside of base 1 providing extra clearance in this area. The recessed area relieves unintended platform to secondary rung contact, and unwanted platform instability is avoided.

Looking to FIG. 5, the present invention includes serpentine shaped Left and Right Upper Rung Hanger Arms 3,4 with previously discussed hanger arm to base hinge knuckles and Upper Rung Hanger Arm Snap Latches extruded and modeled from hanger arm lower ends. The upper rung hanger arms are designed to support weight load shifts toward the rear of the base. To that end, the hanger arms employ known strength/stress enhancing techniques common to plastic injection molding. Similar to base rib arrays 8 (FIG. 3) designed to reduce material use and weight while maintaining strength, both left and right upper rung hanger arms use Upper Rung Hanger Arm Cavity Arrays 39 (FIG. 4) for like purposes.

FIG. 5 illustrates both left and right upper rung hanger arms that include Upper Rung Hanger Arm Jaw Assemblies 33, that are modeled extruded features necessary to fit to and rest over a Typical Ladder Upper Support Rung 46. The left and right jaw assemblies each include an Upper Jaw Segment 34 and a Lower Jaw Segment 35. Similar to the Corrugated Base To Lower Ladder Rung Traction Pads 13, the Corrugated Upper Jaw Segment Grip Pads 36, extruded from the lower surfaces of the upper jaw segments, help grip the upper support rung when mounted to a ladder. Another extruded upper jaw segment feature shared by both left and right upper jaw segments are the Upper Rung Hanger Arm Corrugated Step Down Traction Pads 14. The function of these pads is to provide traction when a user is stepping onto the upper support rung and a misstep falls on the top of an upper rung hanger arm. Without the grip pad surface at that point, traction will be poor and could lead to slipping.

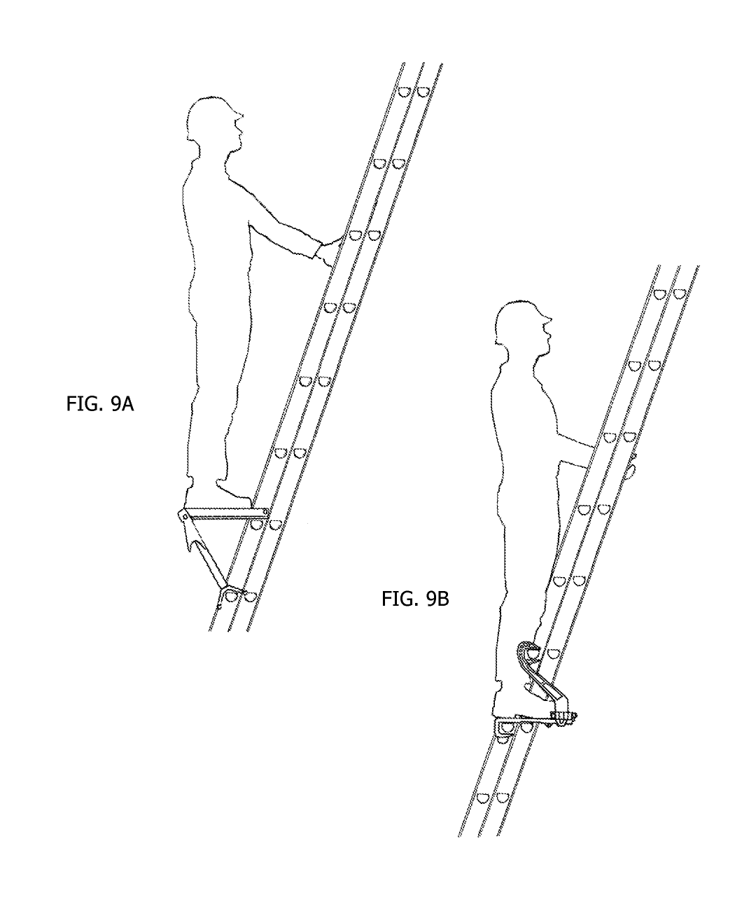

As pointed out in Background of the Invention, serious safety problems of one kind or another have been left unaddressed by previous ladder platform designs, potentially placing a user unnecessarily in jeopardy of injury. A currently popular ladder platform design shown in FIG. 9A has several safety issues including an exposed platform away from a ladder's ‘safe zone’ between the ladder rails and over the supporting rung. User safety is at risk standing on a simple platform base placed outward from a ladder with no edge guard to warn against falling. Stepping up or down the ladder is inhibited by the illustrated device due to the outward reaching platform base that blocks climbing past it. FIG. 9B compares how the Portable Ladder Platform avoids these problems by placing the platform base inward from the supporting rung. The present invention eliminates or reduces several of these and other problems, while also promising to be practical and simple and easy to use.

What is claimed is:

1. A Portable Ladder Platform comprising: a base, wherein the base is designed to sit on a ladder rung A; 2 upper rung hanger arms, wherein 2 upper rung hanger arms attach to said base and hook over and sit on a second ladder rung B adjacent to and above ladder rung A; 2 upper rung hanger arm bolts with locknuts, wherein the 2 upper rung hanger arm bolts with locknuts attach said 2 upper rung hanger arms—to said base; a locking handle, wherein the locking handle attaches to said base; 2 locking handle bolts with locknuts, wherein the 2 locking handle bolts with locknuts attach said locking handle to said base; and a horizontal adjustment dowel, wherein the horizontal adjustment dowel is threaded.

2. The Portable Ladder Platform of claim 1 further comprising: said base, wherein said base is a rectangle including a front, rear, left, and right downward reaching vertical wall around its perimeter; a base rib array, wherein the base rib array extrudes downward from the underside surface of said base and is contained within the perimeter of said 4 base walls; a base locking handle cradle, wherein the locking handle cradle is modeled from and extrudes downward from said base and is encompassed within the perimeter of said 4 base walls providing positioning and supported mounting for said locking handle; and said 2 locking handle bolts with locknuts, wherein said 2 locking handle bolts with locknuts fasten said locking handle to said base locking handle cradle.

3. The Portable Ladder Platform of claim 1 further comprising: a traction grid, wherein the traction grid extrudes upward from said base upper surface to provide enhanced traction for the user; 2 corrugated base-to-ladder rung A traction pads, wherein the 2 base to ladder rung A traction pads when mounted sit directly above ladder rung A so the 2 corrugated base traction pad faces are in contact with ladder rung A; 2 upper rung hanger arm corrugated step down traction pads, wherein the 2 step down traction pads rise from the upper surfaces of said 2 upper rung hanger arms to provide enhanced traction to user movements while said Portable Ladder Platform is mounted on a ladder; and a base rear slip guard ledge, wherein the base rear slip guard ledge provides a barrier to resist slippage while using said Portable Ladder Platform mounted on a ladder.

4. The Portable Ladder Platform of claim 1 further comprising: 2 upper rung hanger arm snap latches, wherein the 2 upper rung hanger arm snap latches secure said 2 upper rung hanger arms in upright positions when said Portable Ladder Platform is mounted to a ladder; 2 base lower rung hooks, wherein the 2 lower rung hooks are created by 2 extrusions vertically downward and horizontally rearward from front wall of said base; said 2 lower rung hooks, whereas each of said 2 lower rungs form 3 sides of a 4 sided ladder rung A containment area; a threaded dowel socket, wherein the threaded dowel socket is a feature of 1 of 2 said lower rung hooks; 1 of 2 said lower rung hooks, wherein the 1 said lower rung hook includes said threaded dowel socket as an extrusion downward; and said threaded dowel socket, wherein said horizontal adjustment dowel is screwed into said threaded dowel socket.

5. The Portable Ladder Platform of claim 1 further comprising: 6 base hinge knuckles, wherein the 6 base hinge knuckles extrude upward from upper surface of said base; 4 upper rung hanger arm hinge knuckles, wherein the 4 upper rung hanger arm hinge knuckles extrude from bottoms of said 2 upper rung hanger arms; said 2 upper rung hanger arm bolts with locknuts, wherein said bolts with locknuts serve as hinge pins to connect said 6 base hinge knuckles with said 4 upper rung hanger arm hinge knuckles; said 6 base hinge knuckles with said 4 upper rung hanger arm hinge knuckles and said 2 upper rung hanger arm mounting bolts with locknuts, wherein the assembly of these parts form 2 pivoting hinges to connect said 2 upper rung hanger arms with said base; and 4 upper rung hanger arm pivot restriction corners, wherein the 4 pivot restriction corners extrude from said 4 upper rung hanger arm hinge knuckles to restrict pivoting of said 2 upper rung hanger arms beyond a 90 degree angle outward to reach no further than a vertical position upward from said base;

[symbol]

6. The Portable Ladder Platform of claim 1 further comprising: 2 locking handle side rails, wherein the 2 locking handle side rails extend equal to the distance from rear to front of said base locking handle cradle; said 2 locking handle side rails, wherein said 2 locking handle side rails rest into said base locking handle cradle so that upper surfaces of said 2 locking handle side rails sit flush with said base upper surface; 4 base locking handle cradle hinge knuckles, wherein the 4 base locking handle cradle hinge knuckles extrude downward from rear of said locking handle cradle; 2 locking handle hinge knuckles, wherein the 2 locking handle hinge knuckles extrude downward and rearward from rear ends of said 2 locking handle side rails; 2 base locking handle cradle hinge knuckle passages, wherein said base locking handle cradle includes 2 top to bottom through openings positioned at the rear end of said base locking handle cradle directly below and in line with fitted said 2 locking handle side rails; 2 base locking handle cradle hinge knuckle passages, wherein said 2 base locking handle cradle hinge knuckle passages permit alignment of said 2 locking handle hinge knuckles with said 4 base locking handle cradle hinge knuckles for assembly; said 4 base locking handle cradle hinge knuckles with said 2 locking handle hinge knuckles and said 2 locking handle bolts with locknuts, whereas the assembly of these parts form 2 pivoting hinges; 2 base locking handle cradle limitation pads, wherein the 2 base locking handle cradle limitation pads are angled surfaces above and behind said 2 base locking handle cradle hinge knuckle passages; and said 2 base locking handle cradle limitation pads, wherein said 2 locking handle hinge knuckles will not pass beyond said 2 base locking handle cradle limitation pads when assembled inhibiting pivot range of said locking handle.

7. The Portable Ladder Platform of claim 1 further comprising: a locking handle grip rod, wherein the locking handle grip rod is an oval rod that extends perpendicular between and connects to said front ends of said 2 locking handle side rails to serve as a grip for pivoting said locking handle in an up or down motion; said locking handle grip rod, wherein said locking handle grip rod serves as a grip for lifting and positioning said Portable Ladder Platform during mounting or dismounting; 2 locking handle gate prongs, wherein the two locking handle gate prongs extrude downward from the front ends of said 2 locking handle side rails; 2 base locking handle cradle gate prong passages, wherein the base locking handle cradle gate prong passages are 2 top to bottom through openings at front end of the locking handle cradle directly below said 2 locking handle gate prongs; said 2 base locking handle cradle gate prong passage front through openings, wherein occurs passage of said 2 locking handle gate prongs through the depth of said base; and said 2 locking handle gate prongs, whereas raising or lowing said locking handle controls the formation of a 4 sided ladder rung A containment area within said 2 base lower rung hooks for containment or release of said ladder rung A.

8. The Portable Ladder Platform of claim 1 further comprising: 2 upper rung hanger arm jaw assemblies, wherein the 2 jaw assemblies extrude perpendicular and rearward from the topmost area of said 2 upper rung hanger arms; said 2 upper rung hanger arm jaw assemblies, wherein said 2 upper rung hanger arm jaw assemblies consist of 2 upper and 2 lower jaw segments; said 2 upper and 2 lower jaw segments, wherein said 2 upper and 2 lower jaw segments form the top and bottom sides of said 2 upper rung hanger arm jaw assemblies; said 2 upper rung hanger arm upper jaw segments, whereas said Portable Ladder Platform mounted to a ladder includes the 2 upper jaw segments sitting on said second ladder rung B; 2 upper rung hanger arm upper jaw segments, wherein 2 corrugated upper jaw segment grip pads extrude downward from lower surface of said 2 upper rung hanger arm upper jaw segments to contact said second ladder rung B; and said 2 upper rung hanger arm lower jaw segments, whereas said 2 upper rung hanger arm lower jaw segments extended rearward directly below second ladder rung B to inhibit unintentional lift of said Portable Ladder Platform.

9. The Portable Ladder Platform of claim 1 further comprising: said 2 upper rung hanger arms, wherein said 2 upper rung hanger arms are 4 sided serpentine contours reaching from said base to said second ladder rung B; said 2 upper rung hanger arm 4 sided serpentine contours, wherein each upper rung hanger arm 4 sided serpentine contour consists of 2 narrow sides and 2 broad sides; connecting at 90° corners; 2 upper rung hanger arm cavity arrays, wherein the 2 upper rung hanger arm cavity arrays are indented areas in said 2 upper rung hanger arms to reduce said Portable Ladder Platform overall weight and strengthen stress capacities of said 2 upper rung hanger arms; and said 2 upper rung hanger arm cavity arrays, wherein each upper rung hanger arm includes 1 cavity array applied in a like pattern along each of said 2 broad sides of said serpentine contours of said 2 upper rung hanger arms.

10. The Portable Ladder Platform of claim 1 further comprising: said 2 upper rung hanger arm snap latches, wherein said 2 upper rung hanger arm snap latches extrude vertically downward from the outward sides of said 2 upper rung hanger arms adjacent to said 4 upper rung hanger arm hinge knuckles; said upper rung hanger arm snap latches, wherein said 2 upper rung hanger arm snap latches latch to said base wall lower edge when pivoted to an upright position; said 2 upper rung hanger arm snap latches, whereas 2 snap latches include 2 snap latch catching levers; and said 2 upper rung hanger arm snap latches, whereas either snap latch is released from locked upright position when force moves said snap latch lower catching lever outward to clear said base wall allowing free inward pivot movement of said upper rung hanger arm.

11. The Portable Ladder Platform of claim 1 further comprising: said horizontal adjustment dowel, wherein the horizontal adjustment dowel is unthreaded and enlarged at one end to serve as a hand adjustable knob for screwing said horizontal adjustment dowel through said base threaded socket.
